(19) United States
(12) Patent Application Publication
(10) Pub. No.: US 2025/0019291 A1
(43) Pub. Date: Jan. 16, 2025

(54) OPTICAL GLASS AND PREPARATION METHOD AND APPLICATION THEREOF

(71) Applicant: CHINA BUILDING MATERIALS ACADEMY CO., LTD., Beijing (CN)

(72) Inventors: Yanhang WANG, Beijing (CN); Tao HAN, Beijing (CN); Xianzi LI, Beijing (CN); Penghui YANG, Beijing (CN); Kun HE, Beijing (CN); Chengkui ZU, Beijing (CN)

(73) Assignee: CHINA BUILDING MATERIALS ACADEMY CO., LTD., Beijing (CN)

(21) Appl. No.: 18/763,841

(22) Filed: Jul. 3, 2024

(30) Foreign Application Priority Data
Jul. 13, 2023 (CN) 202310860310.X

(51) Int. Cl. C03C 3/062

(52) U.S. Cl. CPC C03C 3/062; C03C 2203/10; C03C 2204/00

(57) ABSTRACT

The present application relates to the technical field of glass, in particular to an optical glass and a preparation method and application thereof. The optical glass comprises the following oxide component with the following weight percentage content, La₂O₃: 30%-40%; Ga₂O₃: 15%-25%; Nb₂O₅: 8%-18%; TiO₂: 5%-10%; HfO₂: 5%-10%; Ta₂O₅: 5%-10%; SiO₂: 5%-10%; BaO: 2%-6%; RF₃: 1%-3%, R may be one or both of La and Ga; and C: 0.005%-0.02%. The optical glass has a refractive index equal to or greater than 2.0, an internal transmittance at 440 nm equal to or greater than 93%, and a water resistance stability of grade 1, and can be used in the fields of virtual reality, digital cameras and vehicle display.

### CROSS-REFERENCE TO RELATED APPLICATION

This application claims the benefit of Chinese Application No. 202310860310.X filed Jul. 13, 2023, the entire disclosure of which is hereby incorporated herein by reference.

### TECHNICAL FIELD

The present application relates to the technical field of glass, in particular to an optical glass and a preparation method and application thereof.

### BACKGROUND

Virtual reality uses computer technology to apply virtual information into the real world, the real environment and virtual objects in real time superimposed on the same picture or space existed at the same time, so that people have a sense of immersive feeling. In recent years it has become the focus of the development of information industry. Diffractive waveguide is the key component of virtual reality system, which determines the augmented reality experience of virtual reality system. High refractive index glass belongs to the basic material of diffractive waveguide, and the relatively high refractive index thereof can make the system obtain wider field of view (FOV) and higher optical clarity, and is conducive to the realization of element miniaturization and wearability at the same time.

At present, in view of the characteristics of the components, the high refractive index glass usually contains a relatively high content of TiO₂ and other components which give rise to the coloring of the glass and the reduction of the transmittance of the glass, especially the reduction of light transmittance in the blue light region, thereby the light absorption of glass is increased and the imaging quality is reduced. Therefore, how to prepare the high refractive index glass with high transmittance has become a research hotspot in the field of optical glass.

### SUMMARY OF THE INVENTION

In order to solve the problems of low refractive index, poor internal transmittance of the existing optical glass, etc., the present application provides an optical glass and a preparation method and application thereof. The optical glass of the present application has high refractive index which can significantly improve the light transmittance of the optical glass and expand the application field of the optical glass.

According to a first aspect of the present application, the present application provides an optical glass comprising the following components with the following weight percentage content,
La₂O₃: 30%-40%;
Ga₂O₃: 15%-25%;
Nb₂O₅: 8%-18%;
TiO₂: 5%-10%;
HfO₂: 5%-10%;
Ta₂O₅: 5%-10%;
SiO₂: 5%-10%;
BaO: 2%-6%;
RF₃: 1%-3%, R is selected from one or both of La and Ga; and
C: 0.005%-0.02%.

Further, the optical glass comprises the following components with the following weight percentage content,
La₂O₃: 32%-35%;
Ga₂O₃: 16%-20%;
Nb₂O₅: 12%-15%;
TiO₂: 6%-8%;
HfO₂: 6%-8%;
Ta₂O₅: 5%-8%;
SiO₂: 5%-7%;
BaO: 3%-6%;
RF₃: 1%-2%, R is selected from one or both of La or Ga; and
C: 0.01%-0.015%.

Among the components of the optical glass provided by the present application, SiO₂ component is an important network forming body of the optical glass provided by the present application, which can improve the glass forming ability, strength and chemical stability of the glass. The weight percentage content of SiO₂ component in the examples of the present application is controlled to be from 5% to 10%, preferably from 5% to 7%, which can not only obtain a homogeneous glass body, but also ensure that the glass has a relatively high refractive index. If the weight percentage content of this component is lower than 5%, the glass forming ability and chemical properties of the glass become worse. If the weight percentage content of this component is more than 10%, the refractive index of the glass tends to decrease.

La₂O₃ is an essential component for optical glass to have a relatively high refractive index, and the weight percentage content of this component is controlled to be from 30% to 40%, preferably from 32% to 35%. If the weight percentage content of La₂O₃ component is lower than 30%, it is difficult to ensure that the refractive index of the glass is equal to or greater than 2.0. If the weight percentage content of La₂O₃ component is more than 40%, it lead to crystallization of the glass and worse glass forming ability.

Ga₂O₃ is an essential component for optical glass to have good chemical stability and relatively high refractive index, which can improve water resistance and refractive index of the glass. The weight percentage content of this component is controlled to be from 15% to 5% in the present application, preferably from 16% to 20%. If the weight percentage content of this component is lower than 15%, the water resistance of the glass is not significantly improved. If the weight percentage content of this component is more than 25%, it lead to crystallization of the glass and worse glass forming ability.

Nb₂O₅ is helpful to improve the glass forming ability and refractive index of optical glass, and the weight percentage content of this component is controlled to be from 8% to 18%, preferably from 12% to 15%. If the weight percentage content of this component is less than 8%, the refractive index of the glass is not significantly improved. If the weight percentage content of this component is more than 18%, it is difficult for Nb₂O₅ to fully melt in the glass, and the optical homogeneity of the glass becomes worse.

TiO₂ is an essential component for optical glass to have relatively high refractive index, and the weight percentage content of this component is controlled to be from 5% to 10%, preferably from 6% to 8%. If the weight percentage content of this component is less than 5%, the refractive index of the glass is not significantly improved. If the weight percentage content of this component is more than 10%, the existence of TiO₂ will significantly increase the glass coloring, leading to decrease of the internal transmittance.

HfO₂ is an essential component for optical glass to have a relatively high refractive index, and the weight percentage of this component is controlled to be from 5% to 10%, preferably from 6% to 8%. If the weight percentage content of HfO₂ component is less than 5%, it is difficult to ensure that the refractive index of the glass is equal to or greater than 2.0. If the weight percentage content of HfO₂ component is more than 10%, it lead to crystallization of the glass and worse glass forming ability.

Ta₂O₅ is an essential component for optical glass to have excellent chemical stability, and the weight percentage content of this component is controlled to be from 5% to 10%, preferably from 5% to 8%. If the weight percentage content of this component is less than 5%, the chemical stability of the glass is not significantly improved. If the weight percentage content of this component is more than 10%, it lead to crystallization of the glass and worse glass forming ability.

BaO is an essential component for optical glass to have a relatively high refractive index, and the weight percentage content of this component is controlled to be from 2% to 6%, preferably from 3% to 6%. If the weight percentage content of BaO component is less than 2%, it is difficult to ensure that the refractive index of the glass is equal to or greater than 2.0. If the weight percentage content of BaO component is more than 6%, the chemical stability of the glass becomes worse.

RF₃ component is used as a decolorant for optical glass. The weight percentage content of this component is controlled to be from 1% to 3% in the examples of the present application, preferably from 1% to 2%. If the weight percentage content of this component is less than 1%, the coloring in the glass cannot be completely eliminated, and the high transmittance glass cannot be obtained. If the weight percentage content of this component is more than 3%, excessive fluoride will corrode the Pt crucible, the optical quality of the glass will be reduced, and even the crucible will be broken.

Component C is used as a decolorant for optical glass. The weight percentage content of this component is controlled to be from 0.005% to 0.02% in the examples of the present application, preferably from 0.01% to 0.015%. If the weight percentage content of this component is lower than 0.005%, the coloring in the glass cannot be completely eliminated, and the high transmittance glass cannot be obtained. If the weight percentage content of this component is more than 0.015%, the Pt crucible will be corroded, the optical quality of the glass will be reduced, and even the crucible will be broken.

In the above scheme, the raw materials of optical glass in the present application is selected from several components of La₂O₃, Ga₂O₃, Nb₂O₅, TiO₂, HfO₂, Ta₂O₅, SiO₂, BaO, RF₃ and C. The amount of each component is specially limited to fully play the synergistic effect among the components, so that the obtained optical glass has the characteristics of high refractive index, high internal transmittance and good water resistance stability, so as to expand its application field.

Further, the optical glass has a refractive index equal to or greater than 2.0, an internal transmittance at 440 nm equal to or greater than 93%, and a water resistance stability better than grade 1.

The optical glass with the above characteristics can be well used as a lens in the fields of virtual reality system, digital camera, or vehicle display, etc.

According to the second aspect of the present application, the present application also provides a method for preparing the above optical glass, which comprises the following steps:
(1) weighing the corresponding raw materials according to the contents of various components of the optical glass, and mixing evenly; and
(2) smelting the evenly mixed raw materials at high temperature under the condition of N₂ protection, using mechanical stirring to clarify and homogenize, casting moulding, annealing, and obtaining the optical glass with high refractive index.

In the above scheme, in the method for preparing the optical glass of the present application, firstly the various raw materials are mixed evenly, then the evenly mixed raw materials were melted at high temperature under the condition of N₂ protection, mechanical stirring was used to clarify and homogenize, and the optical glass was obtained after casting moulding and annealing. The optical glass obtained by the above scheme has a high refractive index. Moreover, the optical glass of the present application contains a lower amount of TiO₂, RF₃ and a very small amount of C as components, and N₂ atmosphere is adopted, thus the internal transmittance of the optical glass at 440 nm can be improved.

Further, the devices used for melting at high-temperature comprises a high-temperature melting furnace with protective atmosphere, a Pt-20Rh crucible and a Pt-30Rh agitator.

If using pure Pt crucible and agitator, high temperature molten glass erodes it to a greater extent, forming Pt flash point, which results in worse transmittance and optical homogeneity of glass. In the above scheme, Pt-20Rh crucible and Pt-30Rh agitator are used for melting of glass at high temperature, which is conducive to improve light transmittance and optical homogeneity of optical glass.

Further, in the process of smelting at high temperature, N₂ with a purity of 5N is passed into the furnace chamber, and the pressure in the furnace chamber is in a range from 0.11 MPa to 0.13 Mpa.

In the above scheme, by limiting the purity of the gas in the furnace chamber and pressure of the furnace chamber in the process of smelting at high temperature, the content of oxygen in the furnace chamber can be reduced, thereby preventing the ions in the glass from existing in the form of high valance state.

Further, in the process of smelting at high temperature, a Pt-30Rh gate type agitator is used to stir at a rotational speed ranging from 50 rpm to 80 rpm for a stirring time ranging from 2 hours to 4 hours to promote the clarification and homogenization of molten glass.

In the above scheme, the type of agitator, rotational speed of stirring and time of stirring used in the process of smelting at high temperature are further defined, which is conducive to improving the efficiency of smelting at high temperature.

Further, the smelting at high temperature is carried out at a temperature ranging from 1,400° C. to 1,450° C. for a time period ranging from 4 hours to 8 hours.

In the above scheme, by limiting the temperature and time of smelting at high temperature in a reasonable range values, it can ensure that the various raw materials are heated at high temperature to form a homogeneous, bubble-free molten glass meeting the moulding requirements, which is conducive to the subsequent processing and moulding.

Further, the casting moulding is carried out at a moulding temperature ranging from 1,150° C. to 1,250° C., and a mould is preheated at a temperature ranging from 500° C. to 560° C.

In the above scheme, by limiting the moulding temperature of the casting moulding and the preheating temperature of the mould in a reasonable range of values, the efficiency of casting moulding can be improved.

Further, the annealing is carried out at a temperature ranging from 700° C. to 730° C. for a time period ranging from 3 hours to 5 hours.

In the above scheme, by limiting the annealing temperature and annealing time in a reasonable range of values, it is beneficial to better eliminate the stress in the optical glass, and improve its light transparency and mechanical strength.

According to the third aspect of the present application, the present application also provides the use of the above optical glass as a lens in a virtual reality system, a digital camera, or a vehicle display.

One or more technical schemes provided in the examples of the present application have at least the following technical effects or advantages:
1. the components of the optical glass provided by the examples of the present application comprise a relatively large amount of heavy metal oxides such as La₂O₃, Nb₂O₅, HfO₂ and BaO, which improves the refractive index of the glass body and ensures that the refractive index of the glass is equal to or greater than 2.0;
2. the components of the optical glass provided by the examples of the present application contain a certain amount of Ga₂O₃ and Ta₂O₅, which significantly improves the chemical stability of the glass and elevates the water resistance stability from grade 3 to grade 1;
3. the components of the high-refractive index glass provided by the examples of the present application contain a lower amount of TiO₂, RF₃ and a very small amount of C, and an N₂ atmosphere is adopted to improve the internal transmittance of the glass at 440 nm from 88% to 93%; and
4. the optical glass provided by the examples of the present application has comprehensive performances, such as, refractive index greater than or equal to 2.0, relatively high internal transmittance, excellent chemical stability, etc., and can be used in the fields of virtual reality, digital camera, vehicle display, etc.

### DETAILED DESCRIPTION

In order to make the purpose, technical scheme and advantages of the present application clearer, the technical scheme of the present application is described clearly and completely below. Obviously, the examples described are part of the examples of the present application, but not all examples. Based on the examples of the present application, all other examples obtained by those skilled ordinary in the art without making creative work will fall within the protection scope of the present application.

Among the components of the glass provided by the examples of the present application, SiO₂ is the basic component and the corresponding raw material is quartz sand. The functional components of the glass provided by the examples of the present application are La₂O₃, Ga₂O₃, Nb₂O₅, TiO₂, HfO₂, Ta₂O₅, BaO, RF₃ and C, and these functional components all can be oxide/fluoride/elementary substance itself, the corresponding carbonate, or the corresponding nitrate. These basic components with the functional components together are used to prepare the optical glass.

### Example 1

The present example provides an optical glass, and the weight percentage contents of various components of the optical glass are shown in Table 1 below, and the preparation method thereof comprises the following steps:
weighing the corresponding weight of raw materials according to the components of the optical glass in Table 1; and mixing these raw materials evenly to obtain the mixed materials; adding the mixed materials ball into the Pt-20Rh crucible; melting at high temperature of 1450° C. for 8 hours under the condition of N₂ protection and the pressure of 0.11 MPa in the furnace chamber, and using Pt-30Rh agitator to mechanically stir the molten glass at a rotational speed of 80 rpm for a stirring time of 4 hours; casting the homogenized molten glass into the preheated mould with a temperature of 560° C. by using the method of casting moulding at a moulding temperature of 1250° C.; annealing the glass after moulding at 730° C. for 3 hours and turning off the power supply of annealing furnace; and finally testing the performance of the optical glass.

### Example 2

The present example provides an optical glass, and the weight percentage contents of various components of the optical glass are shown in Table 1 below, and the preparation method thereof comprises the following steps:
weighing the corresponding weight of raw materials according to the components of the optical glass in Table 1; and mixing these raw materials evenly to obtain the mixed materials; adding the mixed materials ball into the Pt-20Rh crucible; melting at high temperature of 1420° C. for 4 hours under the condition of N₂ protection and the pressure of 0.11 MPa in the furnace chamber, and using Pt-30Rh agitator to mechanically stir the molten glass at a rotational speed of 60 rpm for a stirring time of 3 hours; casting the homogenized molten glass into the preheated mould with a temperature of 520° C. by using the method of casting moulding at a moulding temperature of 1150° C.; annealing the glass after moulding at 720° C. for 4 hours, and turning off the power supply of annealing furnace; and finally testing the performance of the optical glass.

### Example 3

The present example provides an optical glass, and the weight percentage contents of various components of the optical glass are shown in Table 1 below, and the preparation method thereof comprises the following steps:
weighing the corresponding weight of raw materials according to the components of the optical glass in Table 1; and mixing these raw materials evenly to obtain the mixed materials; adding the mixed materials ball into the Pt-20Rh crucible; melting at high temperature of 1400° C. for 6 hours under the condition of N₂ protection and the pressure of 0.11 MPa in the furnace chamber, and using Pt-30Rh agitator to mechanically stir the molten glass at a rotational speed of 50 rpm for a stirring time of 2 hours; casting the homogenized molten glass into the preheated mould with a temperature of 540° C. by using the method of casting moulding at a moulding temperature of 1180° C.; annealing the glass after moulding at 710° C. for 4 hours and turning off the power supply of annealing furnace; and finally testing the performance of the optical glass.

### Example 4

The present example provides an optical glass, and the weight percentage contents of various components of the optical glass are shown in Table 1 below, and the preparation method thereof comprises the following steps:
weighing the corresponding weight of raw materials according to the components of the optical glass in Table 1; and mixing these raw materials evenly to obtain the mixed materials; adding the mixed materials ball into the Pt-20Rh crucible; melting at high temperature of 1450° C. for 5 hours under the condition of N₂ protection and the pressure of 0.13 MPa in the furnace chamber, and using Pt-30Rh agitator to mechanically stir the molten glass at a rotational speed of 50 rpm for a stirring time of 3 hours; casting the homogenized molten glass into the preheated mould with a temperature of 500° C. by using the method of casting moulding at a moulding temperature of 1200° C.; annealing the glass after moulding at 700° C. for 5 hours and turning off the power supply of annealing furnace; and finally testing the performance of the optical glass.

### Example 5

The present example provides an optical glass, and the weight percentage contents of various components of the optical glass are shown in Table 1 below, and the preparation method thereof comprises the following steps:
weighing the corresponding weight of raw materials according to the components of the optical glass in Table 1; and mixing these raw materials evenly to obtain the mixed materials; adding the mixed materials ball into the Pt-20Rh crucible; melting at high temperature of 1430° C. for 4 hours under the condition of N₂ protection and the pressure of 0.13 MPa in the furnace chamber, and using Pt-30Rh agitator to mechanically stir the molten glass at a rotational speed of 80 rpm for a stirring time of 3 hours; casting the homogenized molten glass into the preheated mould with a temperature of 500° C. by using the method of casting moulding at a moulding temperature of 1150° C.; annealing the glass after moulding at 700° C. for 5 hours and turning off the power supply of annealing furnace; and finally testing the performance of the optical glass.

### Example 6

The present example provides an optical glass, and the weight percentage contents of various components of the optical glass are shown in Table 1 below, and the preparation method thereof comprises the following steps:
weighing the corresponding weight of raw materials according to the components of the optical glass in Table 1; and mixing these raw materials evenly to obtain the mixed materials; adding the mixed materials ball into the Pt-20Rh crucible; melting at high temperature of 1420° C. for 5 hours under the condition of N₂ protection and the pressure of 0.12 MPa in the furnace chamber, and using Pt-30Rh agitator to mechanically stir the molten glass at a rotational speed of 60 rpm for a stirring time of 4 hours; casting the homogenized molten glass into the preheated mould with a temperature of 520° C. by using the method of casting moulding at a moulding temperature of 1250° C.; annealing the glass after moulding at 720° C. for 4 hours and turning off the power supply of annealing furnace; and finally testing the performance of the optical glass.

### Example 7

The present example provides an optical glass, and the weight percentage contents of various components of the optical glass are shown in Table 1 below, and the preparation method thereof comprises the following steps:
weighing the corresponding weight of raw materials according to the components of the optical glass in Table 1; and mixing these raw materials evenly to obtain the mixed materials; adding the mixed materials ball into the Pt-20Rh crucible; melting at high temperature of 1450° C. for 8 hours under the condition of N₂ protection and the pressure of 0.11 MPa in the furnace chamber, and using Pt-30Rh agitator to mechanically stir the molten glass at a rotational speed of 70 rpm for a stirring time of 2 hours; casting the homogenized molten glass into the preheated mould with a temperature of 560° C. by using the method of casting moulding at a moulding temperature of 1180° C.; annealing the glass after moulding at 710° C. for 4 hours and turning off the power supply of annealing furnace; and finally testing the performance of the optical glass.

### Example 8

The present example provides an optical glass, and the weight percentage contents of various components of the optical glass are shown in Table 1 below, and the preparation method thereof comprises the following steps:
weighing the corresponding weight of raw materials according to the components of the optical glass in Table 1; and mixing these raw materials evenly to obtain the mixed materials; adding the mixed materials ball into the Pt-20Rh crucible; melting at high temperature of 1400° C. for 6 hours under the condition of N₂ protection and the pressure of 0.11 MPa in the furnace chamber, and using Pt-30Rh agitator to mechanically stir the molten glass at a rotational speed of 50 rpm for a stirring time of 2 hours; casting the homogenized molten glass into the preheated mould with a temperature of 540° C. by using the method of casting moulding at a moulding temperature of 1200° C.; annealing the glass after moulding at 730° C. for 3 hours and turning off the power supply of annealing furnace; and finally testing the performance of the optical glass.

### Comparative Example 1

The present Comparative Example provides an optical glass, and the weight percentage contents of various components of the optical glass are shown in Table 2 below, and the preparation method thereof is the same as that of Example 6.

### Comparative Example 2

The present Comparative Example provides an optical glass, and the weight percentage contents of various components of the optical glass are shown in Table 2 below, and the preparation method thereof is the same as that of Example 6.

### Comparative Example 3

The present Comparative Example provides an optical glass, and the weight percentage contents of various components of the optical glass are shown in Table 2 below, and the preparation method thereof is the same as that of Example 6.

### Comparative Example 4

The present Comparative Example provides an optical glass, and the weight percentage contents of various components of the optical glass are shown in Table 2 below, and the preparation method thereof is the same as that of Example 6, except that the melting in the preparation process of optical glass is in atmospheric environment without N₂.

| Components (weight | Examples | | | | | | | |
|---|---|---|---|---|---|---|---|---|
| percentage content/%) | 1 | 2 | 3 | 4 | 5 | 6 | 7 | 8 |
| La₂O₃ | 40 | 36 | 30 | 31 | 34 | 32 | 35 | 35 |
| Ga₂O₃ | 15 | 20 | 25 | 17 | 16 | 20 | 18 | 19 |
| Nb₂O₅ | 12 | 17 | 18 | 8 | 15 | 15 | 12 | 13 |
| TiO₂ | 5 | 5 | 5 | 10 | 8 | 6 | 8 | 8 |
| HfO₂ | 8 | 5 | 6 | 10 | 8 | 6 | 8 | 7 |
| Ta₂O₅ | 10 | 5 | 6 | 7 | 7 | 8 | 8 | 5 |
| SiO₂ | 5 | 6 | 6 | 10 | 6 | 5 | 7 | 6 |
| BaO | 2 | 5 | 2 | 4 | 4 | 6 | 3 | 6 |
| LaF₃ | 3 | 1 | 1 | 0 | 0 | 2 | 1 | 0 |
| GaF₃ | 0 | 0 | 1 | 3 | 2 | 0 | 0 | 1 |
| C | 0.005 | 0.02 | 0.01 | 0.01 | 0.015 | 0.012 | 0.01 | 0.01 |
| Refractive index (587.6 nm) | 2.01572 | 2.00064 | 2.00247 | 2.00386 | 2.01672 | 2.01567 | 2.02122 | 2.02156 |
| Internal transmittance | 93.1 | 93.2 | 93.1 | 93.1 | 93.5 | 93.4 | 93.4 | 93.5 |
| (%, 440 nm) | | | | | | | | |
| Water resistance stability (grade) | 1 | 1 | 1 | 1 | 1 | 1 | 1 | 1 |
| Optical homogeneity (×10⁻⁶) | 8 | 6 | 8 | 6 | 5 | 4 | 2 | 4 |

### Comparative Example 5

The present Comparative Example provides an optical glass, and the weight percentage contents of various components of the optical glass are shown in Table 2 below, and the preparation method thereof is the same as that of Example 6.

### Comparative Example 6

The present Comparative Example provides an optical glass, and the weight percentage contents of various components of the optical glass are shown in Table 2 below, and the preparation method thereof is the same as that of Example 6, except that a pure Pt crucible and a pure Pt agitator are used in the preparation process of optical glass.

### Comparative Examples 7-9

The present Comparative Example provides an optical glass, and the weight percentage contents of various components of the optical glass are shown in Table 2 below, and the preparation method thereof is the same as that of Example 6.

The performances of the optical glasses prepared by the examples and comparative examples are tested according to the following methods, and the specific performance test results are shown in Table 1.

The refractive index is tested according to the method of GB/T 7962.1-2010, “Test methods of colorless optical glass—Part 1: Refractive index and coefficient of dispersion”.

The internal transmittance is tested according to the method of GB/T 7962.12-2010, “Test methods of colorless optical glass—Part 12: Spectral internal transmittance”.

The water resistance stability is tested according to the method of GB/T 6582-2021, “Glass-Hydrolytic resistance of glass grains at 98° C.—Method of test and classification”.

The optical homogeneity is tested according to the method of GB/T 7962.2-2010, “Test methods of colorless optical glass—Part 2: Optical homogeneity—Fizeau plano—interferometry”.

Table 1. The components and performance test results of the optical glasses in the examples of the present application.

TABLE 2
The components and performance test results of the optical glasses in Example 6 and Comparative Examples of the present application.

| | | Compar- | Compar- | Compar- | Compar- | Compar- | Compar- | Compar- | Compar- | Compar- |
|---|---|---|---|---|---|---|---|---|---|---|
| Components (weight | | ative | ative | ative | ative | ative | ative | ative | ative | ative |
| percentage content/%) | Example6 | Example 1 | Example 2 | Example 3 | Example 4 | Example 5 | Example 6 | Example 7 | Example 8 | Example 9 |
| La₂O₃ | 32 | 32 | 32 | 32 | 32 | 33 | 32 | 32 | 32 | 32 |
| Ga₂O₃ | 20 | 20 | 20 | 20 | 20 | 12 | 20 | 20 | 20 | 20 |
| Nb₂O₅ | 15 | 10 | 15 | 15 | 15 | 15 | 15 | 15 | 15 | 15 |
| TiO₂ | 6 | 15 | 6 | 6 | 6 | 10 | 6 | 6 | 6 | 6 |
| HfO₂ | 6 | 2 | 8 | 6 | 6 | 6 | 6 | 6 | 6 | 0 |
| Ta₂O₅ | 8 | 8 | 8 | 8 | 8 | 2 | 8 | 8 | 8 | 8 |
| SiO₂ | 5 | 5 | 5 | 5 | 5 | 10 | 5 | 5 | 5 | 5 |
| BaO | 6 | 6 | 6 | 6 | 6 | 6 | 6 | 6 | 6 | 6 |
| LaF₃ | 2 | 2 | 0 | 2 | 2 | 6 | 2 | 5 | 0.5 | 2 |
| GaF₃ | 0 | 0 | 0 | 0 | 0 | 0 | 0 | 0 | 0 | 0 |
| C | 0.012 | 0.012 | 0.012 | 0.012 | 0.012 | 0.012 | 0.012 | 0.012 | 0.012 | 0.012 |
| Refractive index (587.6 nm) | 2.01567 | 2.03216 | 2.01512 | 2.01535 | 2.01567 | 2.00143 | 2.00195 | 2.00142 | 2.00201 | 1.96251 |
| Internal transmittance | 93.4 | 86.1 | 72.2 | 75.0 | 78.3 | 93.1 | 70.5 | 93.8 | 85.6 | 82.3 |
| (%, 440 nm) | | | | | | | | | | |
| Water resistance stability | 1 | 1 | 1 | 1 | 1 | 3 | 1 | 3 | 1 | 1 |
| (grade) | | | | | | | | | | |
| Optical homogeneity (×10⁻⁶) | 4 | 5 | 4 | 5 | 4 | 4 | 105 | 4 | 15 | 4 |

It can be seen from Table 1 that the optical glasses prepared by the examples of the present application has comprehensive performances, such as high refractive index (equal to or greater than 2.0), good internal transmittance (equal to or greater than 930%@440 nm), excellent chemical stability (grade 1) and the like.

It can be seen from Table 2 that when the TiO₂ content in the optical glass of Comparative Example 1 is relatively high, the glass coloring is aggravated, and the internal transmittance is only 86.1%. Since the optical glass of Comparative Example 2 does not contain LaF₃ or GaF₃ fluoride, the Fe ions in the glass exist in the form of high valance state Fe³⁺, the glass coloring is aggravated, and the internal transmittance is only 72.2%. Since the optical glass of Comparative Example 3 does not contain C, it is not conducive to forming a weak reducing atmosphere in the process of smelting, and Fe ions exist in the form of high valance state Fe³⁺, the glass coloring is aggravated, and the internal transmittance becomes worse. The smelting of the optical glass of Comparative Example 4 is carried out in the atmospheric environment, the Fe ions in the glass cannot exist in the form of low valance state Fe²⁺, resulting in low internal transmittance in the glass. Since the optical glass of Comparative Example 5 contains low content of Ta₂O₅ and Ga₂O₃, the water resistance stability of the glass becomes worse, and the water resistance grade is 3. Due to the use of pure Pt crucible and agitator in the preparation of the optical glass of Comparative Example 6, high temperature molten glass erodes it to a greater extent, forming Pt flash point, which results in worse light transmittance and optical homogeneity of glass. The comparison results of Comparative Examples 7-8 and the examples of the present application show that the weight percentage content of RF₃ component controlled within a reasonable range is conducive to improving the overall performance of the optical glass of the present application. If the weight percentage content of this component is less than 1%, the coloring in the glass cannot be completely eliminated, and the glass with high transmittance cannot be obtained. If the weight percentage content of this component is more than 3%, excessive fluoride will corrode the Pt crucible, the optical quality of the glass will be reduced, and even the crucible will be broken. The comparison results of Comparative Example 9 and the examples of the present application show that it is difficult to ensure that the refractive index of glass is equal to or greater than 2.0 without adding HfO₂ component.

Finally, it should be noted that the above examples are only used to illustrate the technical scheme of the present application, and not to limit it. Although the detailed description of the present application by reference to the foregoing examples, it will be understood by those skilled ordinary in the art that the technical scheme recorded in the foregoing examples may still be modified or some of the technical features are equally substituted. Such modification or substitution will not make the essence of the corresponding technical scheme depart from the spirit and scope of the technical scheme of various examples of the present application.

1. An optical glass, wherein, the optical glass comprises the following components with the following weight percentage contents,
La₂O₃: 30%-40%;
Ga₂O₃: 15%-25%;
Nb₂O₅: 8%-18%;
TiO₂: 5%-10%;
HfO₂: 5%-10%;
Ta₂O₅: 5%-10%;
SiO₂: 5%-10%;
BaO: 2%-6%;
RF₃: 1%-3%, R is selected from one or both of La and Ga; and
C: 0.005%-0.02%.

2. The optical glass according to claim 1, wherein, the optical glass comprises the following components with the following weight percentage contents:
La₂O₃: 32%-35%;
Ga₂O₃: 16%-20%;
Nb₂O₅: 12%-15%;
TiO₂: 6%-8%;
HfO₂: 6%-8%;
Ta₂O₅: 5%-8%;
SiO₂: 5%-7%;
BaO: 3%-6%;
RF₃: 1%-2%, R is selected from one or both of La and Ga; and
C: 0.01%-0.015%.

3. The optical glass according to claim 1, wherein, the optical glass has a refractive index equal to or greater than 2.0, an internal transmittance at 440 nm equal to or greater than 93%, and a water resistance stability better than grade 1.

4. A method for preparing the optical glass according to claim 1, wherein, the method comprises the following steps:
(1) weighing the corresponding raw materials according to the contents of various components of the optical glass, and mixing evenly; and
(2) smelting the evenly mixed raw materials at high temperature under the condition of N₂ protection, using mechanical stirring to clarify and homogenize, casting moulding, annealing, and obtaining the optical glass with high refractive index.

5. The method for preparing the optical glass according to claim 4, wherein, devices for smelting at high temperature comprises a high-temperature melting furnace with protective atmosphere, a Pt-20Rh crucible and a Pt-30Rh agitator.

6. The method for preparing the optical glass according to claim 5, wherein, in the process of smelting at high temperature, N₂ with a purity of 5N is passed into the furnace chamber, and the pressure in the furnace chamber is in a range from 0.11 MPa to 0.13 Mpa;
and/or, in the process of smelting at high temperature, a Pt-30Rh gate type agitator is used to stir at a rotational speed ranging from 50 rpm to 80 rpm for a stirring time ranging from 2 hours to 4 hours to promote the clarification and homogenization of molten glass.

7. The method for preparing the optical glass according to claim 4, wherein, the smelting at high temperature is carried out at a temperature ranging from 1400° C. to 1450° C. for a time period ranging from 4 hours to 8 hours.

8. The method for preparing the optical glass according to claim 4, wherein, the casting moulding is carried out at a moulding temperature ranging from 1150° C. to 1250° C., and a mould is preheated at a temperature ranging from 500° C. to 560° C.

9. The method for preparing the optical glass according to claim 4, wherein, the annealing is carried out at a temperature ranging from 700° C. to 730° C. for a time period ranging from 3 hours to 5 hours.

10. The method for preparing the optical glass according to claim 4, wherein, the optical glass comprises the following components with the following weight percentage contents:
La₂O₃: 32%-35%;
Ga₂O₃: 16%-20%;
Nb₂O₅: 12%-15%;
TiO₂: 6%-8%;
HfO₂: 6%-8%;
Ta₂O₅: 5%-8%;
SiO₂: 5%-7%;
BaO: 3%-6%;
RF₃: 1%-2%, R is selected from one or both of La and Ga; and
C: 0.01%-0.015%.

11. The method for preparing the optical glass according to claim 4, wherein, the optical glass has a refractive index equal to or greater than 2.0, an internal transmittance at 440 nm equal to or greater than 93%, and a water resistance stability better than grade 1.
